(19) United States
(12) Patent Application Publication
(10) Pub. No.: US 2011/0139333 A1
(43) Pub. Date: Jun. 16, 2011

(54) ADHESIVE TAPE JOINING METHOD AND APPARATUS USING THE SAME

(76) Inventors: Masayuki Yamamoto, Osaka (JP); Keigo Funakoshi, Kameyama-shi (JP)

(21) Appl. No.: 12/963,742

(22) Filed: Dec. 9, 2010

(30) Foreign Application Priority Data
Dec. 10, 2009 (JP) 2009-280432

(51) Int. Cl. B29C 65/50; B29C 65/78

(52) U.S. Cl. 156/64; 156/378

(57) ABSTRACT

A tape cutting mechanism cuts an adhesive tape joined to a semiconductor wafer along a contour of the wafer. A rotary encoder detects a rotating angle of each side roller for guiding a narrow region on both ends of an adhesive tape during winding up and collecting a cutout unnecessary tape. A determination section determines a fracture in the narrow region of the unnecessary tape through comparison between an actual rotating angle as a result of the detection and a preset reference rotating angle.

### BACKGROUND OF THE INVENTION

1. Field of the Invention

This invention relates to a method for joining an adhesive tape for protection to a surface of a semiconductor wafer subjected to a surface treatment, and apparatus using this method.

2. Description of the Related Art

For instance, conventional apparatus for joining an adhesive tape is implemented as follows. Firstly, a separator is separated from the adhesive tape with the separator that is fed out from an original master roll. The adhesive tape with the separator separated therefrom is supplied above a semiconductor wafer held on a chuck table. Then, the adhesive tape is joined to a surface of the semiconductor wafer while a joining roller presses the adhesive tape. See, Japanese Patent Publication No. 2004-25438.

The above conventional method, however, has the following problem. The strip adhesive tape with a cutout portion in a wafer shape has a narrow region. Accordingly, the adhesive tape has reduced rigidity. The adhesive tape may be damaged due to an excessive tension applied to this narrow region upon winding up of the adhesive tape. The damage may lead to errors in winding up the adhesive tape.

Moreover, even when no error occurs in winding up the adhesive tape, the adhesive tape with slack may be joined to the wafer that is supplied from upstream once the adhesive tape is cut out. Consequently, wrinkles may occur in the adhesive tape that is joined to the wafer.

### SUMMARY OF THE INVENTION

This invention has one objection to provide an adhesive tape joining method and apparatus using thereof that allow accurate winding up of an unnecessary portion of an adhesive tape after cut out in a shape of a semiconductor wafer and accurate joining of a cutout adhesive tape to the wafer.

This invention discloses an adhesive tape joining method for joining an adhesive tape to a semiconductor wafer. The method includes the steps of cutting an adhesive tape joined to the semiconductor wafer with a tape cutting mechanism; and detecting a rotating state of a guide roller for guiding a narrow region of the adhesive tape having a cutout portion with a detector during winding up and collecting the cutout adhesive tape, and determining a fracture in the narrow region the adhesive tape based on a result of the detection.

According to this method, the guide roller varies in its rotating state due to contact resistance when a narrow region on the both ends of the cutout adhesive tape is passed on the guide roller. The fracture in the adhesive tape is detected in accordance with the variation.

For instance, two or more guide rollers are placed in a tape width direction.

The detector detects a rotation angle of each guide roller. Comparison is made between a preset reference rotation angle and an actual rotation angle for determination of a fracture in the adhesive tape in accordance with an obtained deviation therebetween.

According to another embodiment, the detector detects torque on each guide roller. Comparison is made between preset reference torque and actual torque for determination of a fracture in the adhesive tape in accordance with an obtained deviation therebetween.

Specifically, where the adhesive tape has no fracture, the guide roller rotates in a given pattern in accordance with feed of the adhesive tape. That is because the adhesive tape passed through a predetermined portion always contacts to the guide roller. In other words, the rotation angle of the guide roller or the torque occurring thereon falls within a predetermined value. Consequently, the fracture in the adhesive tape may accurately be detected through detection of variations in the rotation angle or the torque and comparison thereof with a predetermined reference pattern of feeding the tape.

This method is also applicable to a method of joining an adhesive tape to a ring frame and a semiconductor wafer.

This invention also discloses adhesive tape joining apparatus for joining an adhesive tape to a semiconductor wafer. The apparatus includes a holding table; an adhesive tape supply mechanism; a tape joining mechanism; a tape cutting mechanism; a tape separation mechanism; a guide roller; a detector; and a determination section. The holding table holds the semiconductor wafer placed thereon. The adhesive tape supply mechanism supplies the adhesive tape to the semiconductor wafer placed and held on the holding table. The tape joining mechanism with a joining roller rotates the joining roller to join the adhesive tape to the semiconductor wafer while pressing. The tape cutting mechanism cuts the adhesive tape in a wafer shape. The tape separation mechanism separates and winds up the adhesive tape cut in the wafer shape. The guide roller guides a narrow region of the adhesive tape having a cutout portion in the wafer shape during winding up of the adhesive tape. The detector detects a rotating state of the guide roller. The determination section determines a fracture in the narrow region of the adhesive tape based on a result of the detection with the detector.

According to this embodiment, the tape separation mechanism separates the adhesive tape having the cutout portion in the wafer shape, and a narrow region on both ends thereof is passed on the guide roller arranged on both sides of the adhesive tape. The rotating state of the guide roller is detected that varies through contact of the narrow region of the adhesive tape passed on the guide roller. Consequently, the detector may accurately detect the fracture in the narrow region of the adhesive tape.

In the above apparatus, two or more guide rollers may be arranged in a tape width direction. The detector may detect a rotation angle of each guide roller. The determination section may determine a fracture in the narrow region of the adhesive tape in accordance with a deviation that is obtained from comparison between a preset reference rotation angle and an actual rotation angle.

Alternatively, in the above apparatus, two or more guide rollers may be arranged in a tape width direction. The detector may detect torque on each guide roller. The determination section may determine a fracture in the narrow region of the adhesive tape in accordance with deviation that is obtained from comparison between preset reference torque and actual torque.

With this configuration, the above method may suitably be performed.

Here, two or more guide rollers are arranged. Consequently, the narrow region of the cutout adhesive tape may contact to any of the guide rollers even when the narrow region is drawn with tension in a feed direction with no fracture occurring therein and thus the adhesive tape has a narrower width than an actual width. Accordingly, enhanced detection accuracy may be achieved of the fracture in the narrow region.

Moreover, the following configuration is preferable. That is, the guide roller has a middle roller, and side rollers. The middle roller freely rotate about a support shaft, and has a curve shape with a thickness thereof gradually increasing toward a center of the shaft. The side rollers freely rotate about the support shaft on both ends of the middle roller. The side rollers have a peripheral surface of a radius of curvature having a center identical to that of the middle roller.

In other words, the side rollers are arranged on both sides of the middle roller so as to freely rotate about the support shaft. The side rollers have a curve surface following a curve surface of the middle roller that is tapered off outwardly.

According to this configuration, when the guide roller winds up the strip adhesive tape having a cutout portion in the wafer shape, a thick portion of the middle roller enters into the cutout portion in the wafer shape. Thereafter, the middle roller enters into the cutout portion around a center of the adhesive tape as the adhesive tape is wounded up. Consequently, pressure is positively applied to the adhesive tape outwardly, thereby drawing the adhesive tape in a width direction.

That is, tension is applied to the adhesive tape in the tape width direction such that the adhesive tape drawn in a longitudinal direction with back tension during feeding thereof does not have a width smaller than the actual width. As a result, the narrow region of the adhesive tape that remains on both ends thereof after cut out may surely be guided on the side rollers. Accordingly, accurate detection may be realized of the fracture in the adhesive tape from the rotating state.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a general configuration of adhesive tape joining apparatus.

FIG. 2 is a front view of the adhesive tape joining apparatus.

FIG. 3 is an enlarged front view of a separation unit.

FIG. 4 is a rear view of the separation unit.

FIG. 5 is a flow chart showing operations of the exemplary apparatus.

FIGS. 6 to 9 are front views each showing operations of the exemplary apparatus.

FIG. 10 is a front view showing a guide roller according to modified apparatus.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

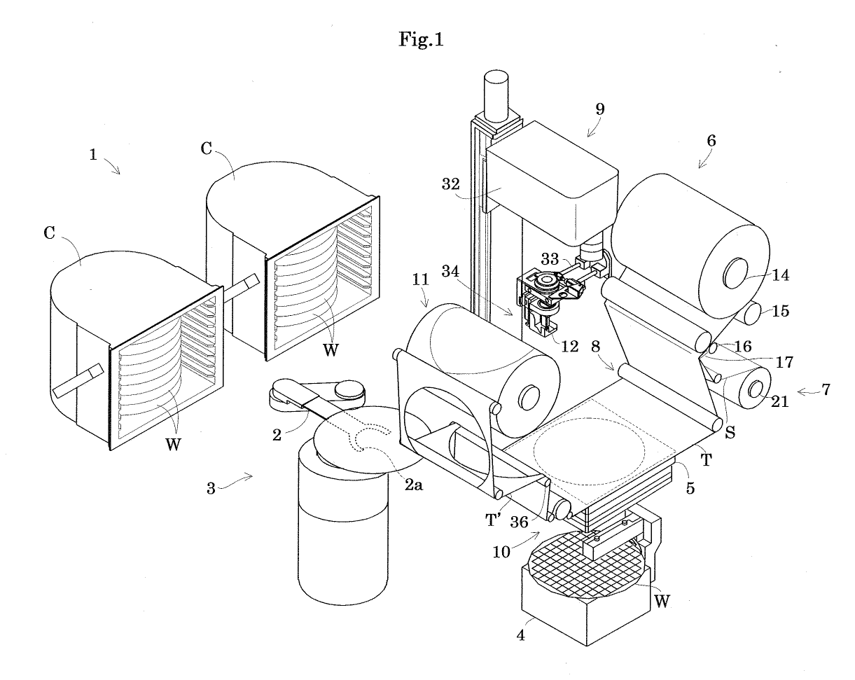

FIG. 1 is a perspective view showing a general configuration of adhesive tape joining apparatus. The adhesive tape joining apparatus includes a wafer supply/collecting section 1 having a cassette C with a semiconductor wafer W (simply referred to as a “wafer”) housed therein, a wafer transport mechanism 3 having a robot arm 2, an alignment stage (aligner) 4, a chuck table 5, a tape supply section 6, a separator collecting section 7, a joining unit 8, a tape cutting mechanism 9, a separation unit 10, and a tape collecting section 11. The chuck table 5 suction-holds the wafer W placed thereon. The tape supply section 6 supplies an adhesive tape T for surface protection provided with a separator s above the wafer W. The separator collecting section 7 separates the separator s from the adhesive tape T supplied from the tape supplying section 6 and collects the separator s. The joining unit 8 joins the adhesive tape T to the wafer W placed on and suction-held by the chuck table 5. The tape cutting mechanism 9 cuts out the adhesive tape T joined to the wafer W along a contour of the wafer W. The separation unit 10 separates an unnecessary tape T′ joined to the wafer W and left out of the wafer W after cutting out the adhesive tape T. The tape collecting section 11 winds up and collects the unnecessary tape T′ separated with the separation unit 10. Hereinafter, detailed description will be given of each structural component and mechanism.

The wafer supply/collecting section 1 has two cassettes C placed in parallel therein. Stacked wafers W, each having a circuit pattern face directed upward, are housed in each cassette C in a horizontal position.

The robot arm 2 of the wafer transport mechanism 3 may move horizontally. Further, the robot arm 2 may turn and move vertically as a whole. The robot arm 2 has at its tip end thereof a horse shoe-shaped wafer holder 2a of a vacuum suction type. The wafer holder 2a is inserted between the stacked wafers W housed in the cassette C, and suction-holds the wafer W on a rear face thereof for pulling out the wafer W from the cassette C. Thereafter, the robot arm 2 transports the wafer W to the alignment stage 4, the chuck table 5, and the wafer supply/collecting section 1, in turn.

The alignment stage 4 performs alignment on the wafer W that is transported and placed thereon by the wafer transport mechanism 3, based on a notch or an orientation flat mark formed at an outer periphery of the wafer W.

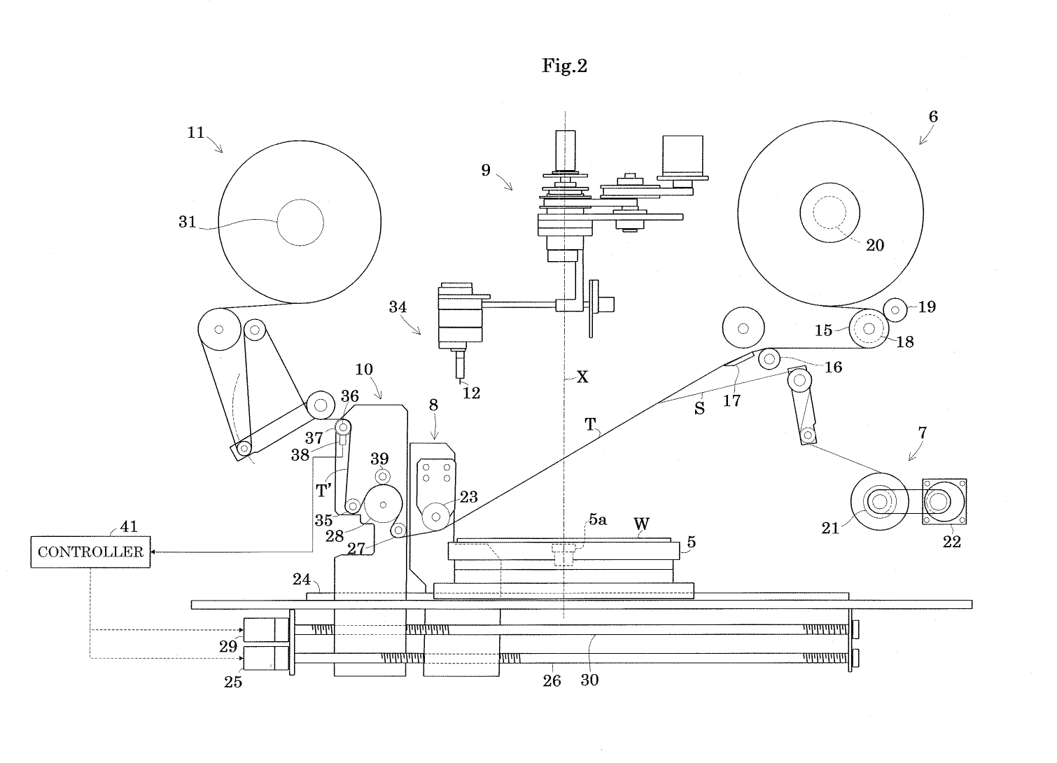

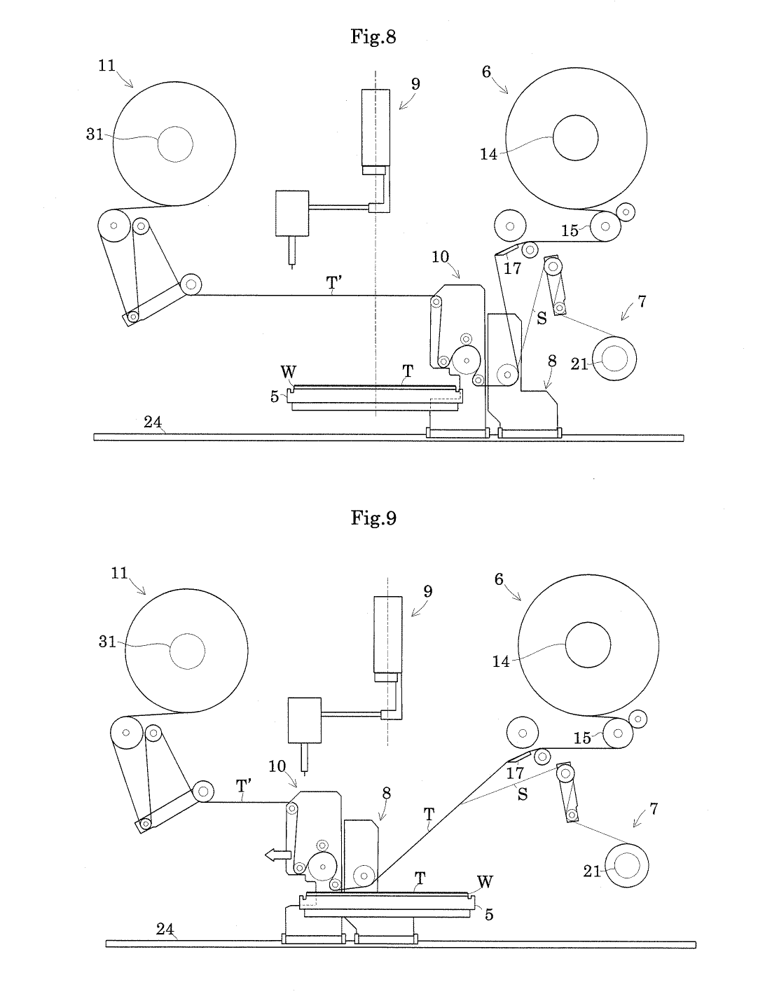

The chuck table 5 vacuum-sucks a wafer W transferred with the wafer transport mechanism 3 and placed in a given alignment position. The chuck table 5 has a cutter traveling groove 13 (see FIG. 6) formed on a top face thereof. In the cutter traveling groove 13, a cutter blade 12 of the tape cutting mechanism 9 turns along an outer periphery of the wafer W for cutting the adhesive tape T. In addition, the chuck table 5 has a suction holder 5a (see FIG. 2) provided on a center thereof so as to move in and out the chuck table 5 upon transfer of the wafer W.

In the tape supplying section 6, as shown in FIG. 2, a feed roller 15 and a guide roller 16 wind up and guide an adhesive tape T with the separator S fed out from a supply bobbin 14, toward a separation guide bar 17 formed into an edge of a knife. The adhesive tape T is folded back at a leading edge of the separation guide bar 17 and, then, is separated from the separator S. The adhesive tape T with the separator S separated therefrom is guided toward the joining unit 8.

The feed roller 15 guides to pinch the adhesive tape T with a pinch roller 19, and is rotated by a motor 18. The feed roller 15 forcibly feeds an adhesive tape T, if necessary.

The supply bobbin 14 is interlocked with and coupled to an electromagnetic brake 20. Thus, appropriate rotational resistance is applied to the supply bobbin 14. As a result, an adhesive tape T is prevented from being excessively fed from the supply bobbin 14.

The separator collecting section 7 includes a collection bobbin 21 for winding up a separator S separated from the adhesive tape T. The collection bobbin 21 is controlled in forward/backward rotation by a motor 22.

The joining unit 8 has a joining roller 23. The joining roller 23 moves upward and downward by a cylinder not shown. Moreover, the joining unit 8 is supported so as to move horizontally along a guide rail 24. The joining unit 8 reciprocates along a screw shaft 26 through backward and forward rotation of a motor 25.

The separating unit 10 includes a separation roller 27, a feed roller 28 driven by a motor, guide rollers 35, 36, and a pinch roller 39. The separation unit 10 is entirely supported along the guide rail 24 so as to move horizontally. The separation unit 10 reciprocates along a screw shaft 30 through backward and forward rotation of a motor 29.

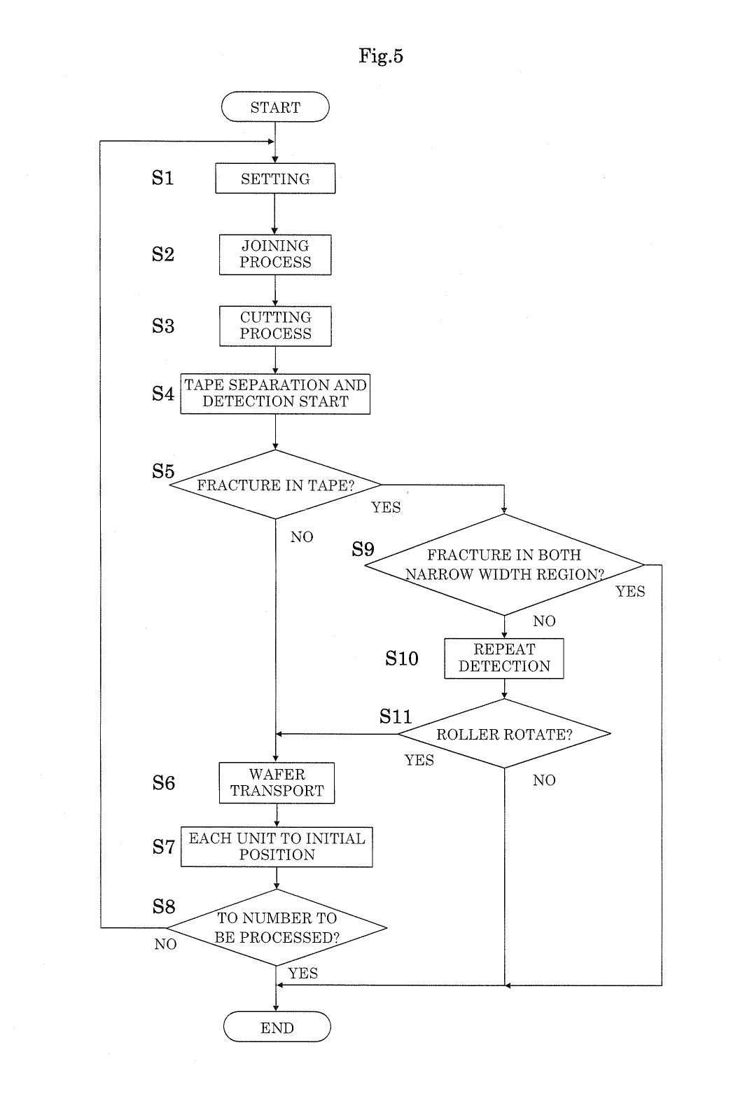

The guide roller 36 has three rollers, i.e., a pair of right and left side rollers 36a and 36b, and a middle roller 36c, as shown in FIG. 4. The side rollers may rotate freely via a bearing about a support shaft fixed to a frame. The middle roller is centered.

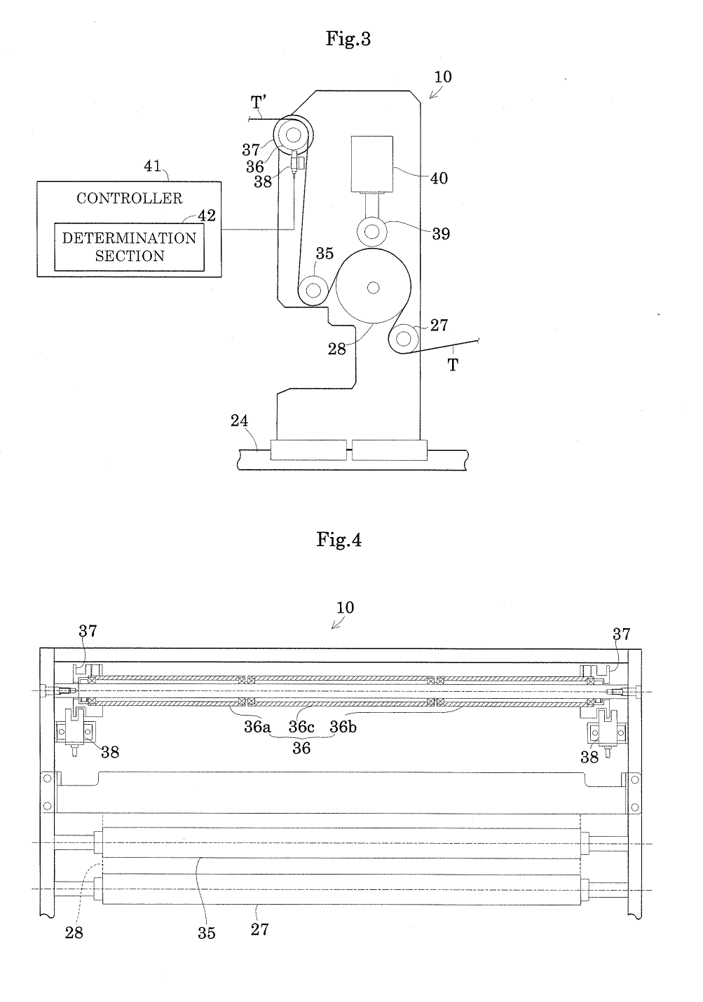

Each of the side rollers 36a, 36b has a slit disc 37 on an outer end thereof. A rotary encoder 38 detecting rotation of the slit disc 37 is arranged on each side roller 36a, 36b side. As shown in FIG. 3, a detection signal from the rotary encoder 38 is transmitted to a controller 41.

The pinch roller 39 moves upward and downward with a cylinder 40. That is, the pinch roller 39 pinches the adhesive tape T with the feed roller 28.

Now referring again to FIG. 2, the tape collecting section 11 has a collection bobbin 31 that is driven by a motor. The collection bobbin 31 rotates in a direction of winding up the unnecessary tape T′.

As shown in FIG. 1, the tape cutting mechanism 9 has a support arm 33 below a movable table 32. The support arm 33 may move vertically so as to turn about a vertical axis X on the center of the chuck table 5. The support arm 33 has a cutter unit 34 on a free end thereof. The cutter unit 34 has the cutter blade 12 having a tip end directed downward.

When the support arm 33 turns about the vertical axis X, the cutter blade 12 travels along the contour of the wafer W to cut out the adhesive tape T into the wafer shape.

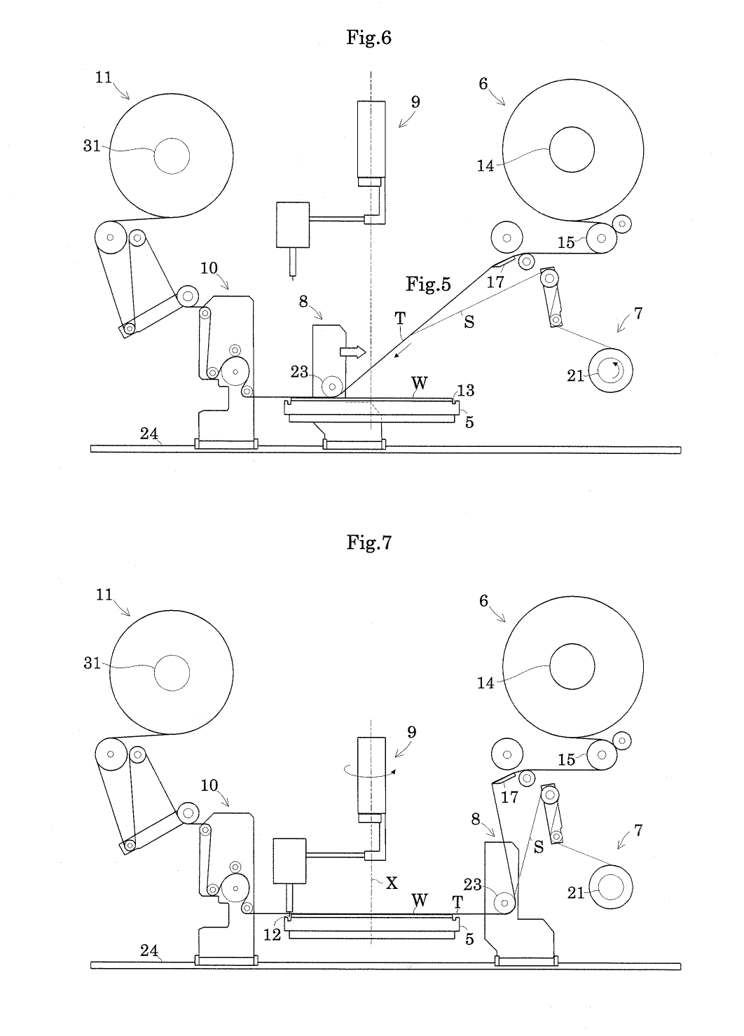

Next, with reference to the flowchart in FIG. 5, and FIGS. 2 and 6 to 9, description will be given of a series of operations for joining a surface-protective adhesive tape T to the surface of the wafer W using the apparatus in the foregoing embodiment.

A joining command is issued, and then the robot arm 2 in the wafer transport mechanism 3 moves towards the cassette C placed on a cassette table. The wafer holder 2a is inserted between the wafers housed in the cassette C. Subsequently, the wafer holder 2a suction-holds the wafer W on the rear face thereof, and pulls out the wafer W, and moves to place the wafer W on the alignment stage 4.

The alignment stage 4 performs alignment of the wafer W placed thereon, through use of a notch or an orientation flat mark formed at the outer periphery of the wafer W. The robot arm 2 then transfers the aligned wafer W toward the chuck table 5, and places the wafer W on the chuck table 5.

The wafer W placed on the chuck table 5 is suction-held so as to be aligned with the chuck table 5. As shown in FIG. 2, herein, the joining unit 8 and the separation unit 10 are each in its initial position. Moreover, the cutter blade 12 of the tape cutting mechanism 9 is standby in its initial position.

The separation unit 10 operates the cylinder 40 to move the pinch roller 39 downward. The pinch roller 39 pinches the adhesive tape T with the feed roller 28 (Step S1.)

Next, as shown in FIG. 6, the joining roller 23 moves downward, and the joining unit 8 moves forward. With this movement, the joining roller 23 rotates while pressing the adhesive tape T against the wafer W. Consequently, the adhesive tape T is to be joined to the surface of the wafer W (Step S2.)

As shown in FIG. 7, when the joining unit 8 reaches a joining termination position across the chuck table 5, the cutter blade 12 on standby on the upper side moves downward. The cutter blade 12 pierces the adhesive tape T on the cutter traveling groove 13 on the chuck table 6.

Next, when the cutter blade 12 moves downward and stops at a level for cutting, the support arm 33 rotates in a given direction. With this rotation, the cutter blade 12 turns about the vertical axis X to cut the adhesive tape T along the outer periphery of the wafer W (Step S3.)

Upon completion of cutting of the adhesive tape T, the cutter blade 12 moves upward to the standby position, as shown in FIG. 8. Simultaneously, the pinch roller 39 in the separation unit 10 moves upward for release of nipping of the adhesive tape T. Then, the separation unit 10 moves to a position where a separation process is completed (Step S4.)

Here, the feed roller 28 is driven at a speed synchronized to a movement speed of the separation unit 10. The feed roller 28 feeds out the unnecessary tape T′ toward the tape collecting section 11. The guide roller 36 that is freely movable rotates through contact resistance with an adhesive surface of the unnecessary tape T′. The rotary encoder 38 detects a rotation angle at this time, and transmits a detection signal to the controller 41.

The determination section 42 in the controller 41 determines whether or not an actual rotation angle detected with the rotary encoder 38 falls within a range of a reference rotation angle obtained in advance through experiments or simulations (Step S5.)

The reference rotation angle may be obtained as follows. The rotation angle of each side roller 36a, 36b is measured from starting winding up of the unnecessary tape T′ having an approximately circular cutout portion to complete passing of the narrow region over both sides of the adhesive tape and sets a new tape into a subsequent tape cutting position. This measurement is repeatedly performed to obtain a mean value. Then, a reference rotation angle is obtained from the mean value.

Alternatively, the reference rotation angle may be determined based on theoretical calculation from a distance (length) of a tape transportation path set in advance and a tape length in the tape cutting position.

Where no fracture in the narrow region of the unnecessary tape T′ is determined from the result with the determination section 42, a normal operation is to be performed (to Step S6.) Upon completion of the adhesive tape joining process, the chuck table 5 releases its suction of the wafer W, and the suction holder 5a holds and lifts the wafer W above the chuck table 5. Then, the wafer holder 2a of the robot arm 2 holds the wafer W to insert the wafer W into the cassette C of the wafer supply/collecting section 1.

Thereafter, as shown in FIG. 9, the separating unit 10 and the joining unit 8 move in a reverse direction to return to its initial position, respectively. Herein, the collection bobbin 31 winds up the unnecessary tape T′ and the tape supply section 6 supplies a given amount of the adhesive tape T.

Thus, one adhesive tape joining process is completed as described above. Thereafter, the foregoing operations are to be performed until the tape joining process is completed for a given number of the wafers W.

Next, description will be given of a case where the actual rotation angle does not fall within the reference rotation angle in Step S5.

Upon detection of a fracture in the narrow region of the unnecessary tape T′, it is determined that the fracture occurs in both ends or any region thereof. That is, it is determined which side roller 36a, 36b has a deviated rotation angle from the given rotation angle (Step S9.)

Where a fracture in one narrow region is detected, the process is to be continued. That is, as shown in FIG. 9, during movement of the separation unit 10 and the joining unit 8 in the reverse direction to return to its initial position, the collection bobbin 31 winds up the unnecessary tape T′ and the tape supply section 6 supplies a given amount of the adhesive tape T.

Herein, upon passage on the guide roller 36 of the portion in the adhesive tape T that follows the cutout portion, the rotary encoder 38 again detects the rotation angles of the side rollers 36a, 36b (Step S10.) That is, it is determined whether or not a new adhesive tape T is normally supplied to a tape joining position. The determination section 42 performs this determination in comparison of the reference rotation angle obtained in advance through experiments and the actual rotation angle.

The determination section 42 determines normal supply of the adhesive tape T when a given rotation angle is detected in accordance with the side rollers 36a, 36b in spite of a fracture in one narrow region. In this case, Step S6 to Step S8 as an usual operation is to be repeated.

On the other hand, the determination section 42 determines abnormal supply of the adhesive tape T due to a fracture in one narrow region, and then the apparatus suspends.

Likewise, where fractures are detected in both narrow regions in Step S9, the apparatus suspends.

As noted above, a series of operations in the foregoing exemplary apparatus is completed.

As above, variation in rotation angle of the guide rollers 36a, 36b are detected due to contact resistance when the narrow region of the unnecessary portion T′ having the cutout portion in the wafer shape passes on the side rollers 36a, 36b of the guide roller 36. Consequently, the fracture in the narrow region of the adhesive tape T may accurately be detected. As a result, the adhesive tape T may entirely be joined to the wafer W with proper tension applied thereto, which results in close joining of the adhesive tape T to the wafer W.

Moreover, it may be determined whether the adhesive tape T to be wounded and collected prior to cut out passes on the side rollers 36a, 36b by a given length during the step of returning the joining unit 8 and the separation unit 10 to its initial position.

That is, the adhesive tape T may be normally supplied to the tape joining position in spite of the fracture in one narrow region upon winding up of the unnecessary tape T′. In this case, the tape joining process may continue.

This invention may be embodied as follows.

In the foregoing embodiment, a fracture in the unnecessary tape T′ is determined from the rotation angles of the side rollers 36a, 36b. Alternatively, the apparatus may suspend upon detection of the fracture with either of the side rollers. Moreover, the side rollers 36a, 36b detect a state of the adhesive tape T to be wound and collected during the step of returning the joining unit 8 and the separation unit 10 to its initial position. The detection process (from Step S9 to Step S11) may be omitted.

The guide roller 36 in the foregoing embodiment is cylindrical. Alternatively, the guide roller 36 may have shapes as follows.

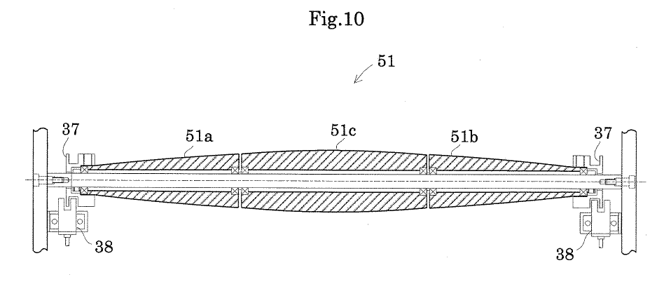

For instance, as shown in FIG. 10, a guide roller 51 may be used having a curve surface of a thickness increasing from both ends of side rollers 51a, 51b toward a center portion of a middle roller 51c in a longitudinal direction. The side rollers 51a, 5b may have a peripheral surface of a radius of curvature having a center identical to that of the middle roller 51c.

According to this configuration, when the guide roller 51 winds up the unnecessary tape T′ having a cutout portion in the wafer shape, a thick portion of the middle roller 51c enters into the cutout portion in the wafer shape. Thereafter, the middle roller 51c enters into the cutout portion around a center of the adhesive tape as the unnecessary tape T′ is wounded up. Consequently, pressure is positively applied to the adhesive tape outwardly, thereby drawing the unnecessary tape T′ in a width direction.

That is, tension is applied to the adhesive tape T in the tape width direction such that the adhesive tape T drawn in a longitudinal direction with back tension during the tape transportation process does not have a width smaller than the actual width. As a result, the narrow region of the unnecessary tape T′ that remains on both ends thereof after cut out may surely be guided on the side rollers 51a, 51b. Accordingly, accurate detection of the fracture in the adhesive tape may be realized from the rotating state of both side rollers 51a, 51b.

The guide roller 36 in the foregoing embodiment is divided into three pieces along the support shaft. Alternatively, the guide roller 36 may be divided into four or more pieces. Moreover, the following configuration may be adopted in consideration of variation in width of the unnecessary tape T′ smaller that an actual width due to drawing with tension in a tape width direction. Specifically, two or more side rollers having an identical width of the narrow region are placed in a range where the narrow region may be passed. In this case, each side roller has a slit disc 37 having a corresponding rotary encoder 38.

With this configuration, the number of the side rollers may appropriately vary in accordance with variation in size of the wafer W. Consequently, setting of the apparatus may readily be changed.

In the foregoing embodiment, the rotation angles of the side rollers 36a, 36b are detected for determination of the fracture in the narrow region of the unnecessary tape T′. Alternatively, the fracture in the narrow region of the unnecessary tape T′ may be determined based on variations in actual rotating torque of both side rollers 36a, 36b.

With this configuration, each side roller 36a, 36b has a torque sensor. Reference torque is given in advance to both side rollers 36a, 36b from contact resistance when the unnecessary portion T′ passes on the side rollers 36a, 36b. Comparison is made of the reference torque and actual measurement torque. Where a deviation occurs therebetween, it may be determined that the narrow region of the unnecessary tape T′ has a fracture.

The foregoing embodiment has described apparatus for joining a surface-protective adhesive tape. For example, this invention is also applicable to wafer mount apparatus for joining a supporting adhesive tape to a ring frame. That is, a winding guide roller may have a rotary encoder and a controller, similar to the foregoing apparatus, such that a strip adhesive tape joined to a ring frame and a wafer is cut out in a circular shape along the ring frame, and thereafter a fracture is detected in the narrow region on both ends of an unnecessary tape.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An adhesive tape joining method for joining an adhesive tape to a semiconductor wafer, comprising the steps of:
cutting the adhesive tape joined to the semiconductor wafer with a tape cutting mechanism; and
detecting a rotating state of a guide roller for guiding a narrow region of the adhesive tape having a cutout portion with a detector during winding up and collecting the cutout adhesive tape, and determining a fracture in the narrow region the adhesive tape based on a result of the detection.

2. The adhesive tape joining method according to claim 1, wherein
two or more guide rollers are placed in a tape width direction,
the detector detects a rotation angle of each guide roller,
comparison is made between a preset reference rotation angle and an actual rotation angle, and
a fracture is determined in the adhesive tape in accordance with an obtained deviation therebetween.

3. The adhesive tape joining method according to claim 1, wherein
two or more guide rollers are placed in a tape width direction,
the detector detects torque on each guide roller,
comparison is made between preset reference torque and actual torque, and
a fracture is determined in the adhesive tape in accordance with an obtained deviation therebetween.

4. An adhesive tape joining method for joining a supporting adhesive tape to a ring frame and a semiconductor wafer, comprising the steps of:
cutting the adhesive tape joined to the semiconductor wafer with a tape cutting mechanism; and
detecting a rotating state of a guide roller for guiding a narrow region of the adhesive tape having a cutout portion with a detector during winding up and collecting the cutout adhesive tape, and determining a fracture in the narrow region the adhesive tape based on a result of the detection.

5. The adhesive tape joining method according to claim 4, wherein
two or more guide rollers are placed in a tape width direction,
the detector detects a rotation angle of each guide roller,
comparison is made between a preset reference rotation angle and an actual rotation angle, and
a fracture is determined in the adhesive tape in accordance with an obtained deviation therebetween.

6. The adhesive tape joining method according to claim 4, wherein
two or more guide rollers are placed in a tape width direction,
the detector detects torque on each guide roller,
comparison is made between preset reference torque and actual torque, and
a fracture is determined in the adhesive tape in accordance with an obtained deviation therebetween.

7. Adhesive tape joining apparatus for joining an adhesive tape to a semiconductor wafer, comprising:
a holding table for holding the semiconductor wafer placed thereon;
an adhesive tape supply mechanism for supplying the adhesive tape to the semiconductor wafer placed and held on the holding table;
a tape joining mechanism with a joining roller for rotating the joining roller to join the adhesive tape to the semiconductor wafer while pressing;
a tape cutting mechanism for cutting the adhesive tape in a wafer shape;
a tape separation mechanism for separating and winding up the adhesive tape cut in the wafer shape;
a guide roller for guiding a narrow region of the adhesive tape having a cutout portion in the wafer shape during winding up of the adhesive tape;
a detector for detecting a rotating state of the guide roller; and
a determination section for determining a fracture in the narrow region of the adhesive tape based on a result of the detection with the detector.

8. The adhesive tape joining apparatus according to claim 7, wherein
two or more guide rollers are arranged in a tape width direction,
the detector detects a rotation angle of each guide roller, and
the determination section determines a fracture in the narrow region of the adhesive tape in accordance with a deviation that is obtained from comparison between a preset reference rotation angle and an actual rotation angle.

9. The adhesive tape joining apparatus according to claim 8, wherein
the guide roller has a middle freely rotating about a support shaft with a curve shape of a thickness gradually increasing toward a center of the shaft, and side rollers freely rotating about the support shaft on both ends of the middle roller, and having a peripheral surface of a radius of curvature with a center identical to that of the middle roller.

10. The adhesive tape joining method according to claim 7, wherein
two or more guide rollers are arranged in a tape width direction,
the detector detects torque on each guide roller, and
the determination section determines a fracture in the narrow region of the adhesive tape in accordance with deviation that is obtained from comparison between preset reference torque and actual torque.

11. The adhesive tape joining method according to claim 7, wherein
the guide roller has a middle freely rotating about a support shaft with a curve shape of a thickness gradually increasing toward a center of the shaft, and side rollers freely rotating about the support shaft on both ends of the middle roller, and having a peripheral surface of a radius of curvature with a center identical to that of the middle roller.
